(19) United States
(12) Patent Application Publication
(10) Pub. No.: US 2007/0165185 A1
(43) Pub. Date: Jul. 19, 2007

(54) ILLUMINATION SYSTEM AN PROJECTION APPARATUS USING THE SAME

(75) Inventor: KO-SHUN CHEN, MIAO-LI COUNTY (TW)

Correspondence Address: J C PATENTS, INC., 4 VENTURE, SUITE 250, IRVINE, CA, 92618, US

(73) Assignee: CORETRONIC CORPORATION, MIAO-LI COUNTY (TW)

(21) Appl. No.: 11/565,284

(22) Filed: Nov. 30, 2006

(30) Foreign Application Priority Data
Jan. 19, 2006 (TW) 95102039

(51) Int. Cl. G03B 21/14

(52) U.S. Cl. 353/20; 353/94

(57) ABSTRACT

An illumination system including a first polarized light source, a second polarized light source and a polarization beam splitter is provided. The first polarized light source is suitable for providing a first light beam with a first polarization direction, and the second polarized light source is suitable for providing a second light beam with a second polarization direction orthogonal to the first polarization direction. The polarization beam splitter is disposed on the intersection of the optical paths of the first light beam and the second light beam for reflecting the first light beam and permitting the second light beam to pass through, such that the first light beam reflected by the polarization beam splitter coincides with the second light beam passing through the polarization beam splitter. Thus, the illumination system provides a light beam with better convergence. Besides, a projection apparatus having the illumination system mentioned above is also provided.

### CROSS-REFERENCE TO RELATED APPLICATION

This application claims the priority benefit of Taiwan application serial no. 95102039, filed Jan. 19, 2006. All disclosure of the Taiwan application is incorporated herein by reference.

### BACKGROUND OF THE INVENTION

1. Field of Invention

The present invention relates to an illumination system and a projection apparatus using the same. More specifically, the present invention relates to an illumination system having multiple light sources and a projection apparatus using the same.

2. Description of Related Art

As the progress of optical projection technology, the projection apparatuses that provide images with high resolution and high brightness have been rapidly developed and widely used. The projection apparatus mainly includes an illumination system, a light valve and an imaging system, while the intensity of the light provided by the illumination system significantly affects the brightness of the projected image. Therefore improving the illumination system has then become an important research subject.

With reference to FIG. 1, an illumination system 100 with dual lamps disclosed in the U.S. Pat. No. 6,196,699 includes a first lamp 110, a second lamp 120 and a reflective component 130 The first lamp 110 faces the second lamp 120, and the optical axes of the first lamp 110 and the second lamp 120 are on the same axis 50 (coaxial design). The reflective component 130 is disposed between the first lamp 110 and the second lamp 120. The reflective component 130 has two reflective surfaces 132 and 134, and the included angles between each reflective surfaces 132, 134 and the axis 50 are respectively 45 degree.

The first and the second lamps 110, 120 respectively include a lampwick 112, 122 and a paraboloid lamp reflector 114, 124. The lampwicks 112, 122 are suitable for providing divergent light, and the paraboloid lamp reflectors 114, 124 are used to convert the divergent light into light beams 112a, 122a. Both the optical axes of the light beams 112a, 122a parallel to the axis 50. In addition, a portion of the light beams 112a, 122a are reflected by the reflective surfaces 132, 134 of the reflective component 130 to form a composite light beam 140. The other portion of the light beams 112a, 122a which are not reflected by the reflective component 130 are reflected to the reflective component 130 by the paraboloid lamp reflector 124, 114, and then are reflected by the reflective surface 134, 132 to form the composite light beam 140.

In the above illumination system 100 with dual lamps, the parallel light beams 112a, 122a are converted into the composite light beam 140 through a plurality of times of reflections, and each reflection slightly reduces the parallelity of the parallel light beams 112a, 122a such that a bigger divergence angle is introduced to the composite light beam 140. Therefore, the Etendue (E) of the composite light beam is increased. The Etendue describes the geometry limit of light irradiation or light collection, the definition of which is: E=πA×sin²(θ_{1/2}), tA is the section area of the light beam, θ_{1/2} is the divergence angle of the light beam. The value of the Etendue of the projection apparatus is determined by the specification of the light valve (for example Digital Micro-mirror Device, DMD) that is used. The value of the Etendue provided in conventional illumination system is greater than the value that the DMD required, therefore the utilization of the light is reduced, and the brightness provided by the illumination system is lost, and consequently it is difficult to increase the brightness of the projection apparatus.

In addition, since the parallel light beams 112a, 122a respectively irradiate the second lamps 120 and the first lamps 110 directly, and pass through the lampwicks 112, 122 repetitively, therefore it is very likely to cause the overheat on the lampwicks 112, 122 and to damage the lampwicks 112, 122. Moreover, when one of the lamps malfunctions, as a result, half of the image projected by the projection apparatus becomes darker. In addition, the configuration of the illumination system 100 with dual lamps is relatively bulky, therefore the volume of the projection apparatus is relatively bulky. At present, the electronic products are pursuing the trend of miniaturization, such as the configuration of the illumination system 100 with dual lamps obviously does not meet the current design requirements.

### SUMMARY OF THE INVENTION

One object of the present invention is directed to provide an illumination system that provides a light beam with a better convergence and higher brightness than that of the conventional illumination system.

Another object of the present invention is directed to provide a projection apparatus which includes an illumination system that provides a light beam with a better convergence and higher brightness, so as to increase the brightness and the light utilization of the projection apparatus.

The present invention provides an illumination system including a first polarized light source, a second polarized light source and a polarized light beam splitter (PBS). The first polarized light source is suitable for providing a first light beam with a first polarization direction, and the second polarized light source is suitable for providing a second light beam with a second polarization direction, the first polarization direction is orthogonal to the second polarization direction. The polarization beam splitter is disposed on the intersection of the optical paths of the first light beam and the second light beam, and is suitable for reflecting the first light beam and permitting the second light beam to pass through, such that the first light beam reflected by the polarization beam splitter coincides with the second light beam passing through the polarization beam splitter. The polarization beam splitter for example is a Polarization Beam Splitting mirror (PBS mirror) or a Polarization Beam Splitting prism (PBS prism).

In addition, the present invention provides another projection apparatus including the previously described illumination system, a light valve and an imaging system. The illumination system is suitable for providing a composite light beam which is formed by coinciding the first light beam with the second light beam. The light valve is disposed on the optical path of the composite light beam, and is suitable for converting the composite light beam into an image light beam. The imaging system is disposed on the optical path of the image light beam.

The first polarized light source includes a first light source and a first polarization component. The first light source is suitable for generating a first light beam, and the first polarization component is disposed on the optical path of the first light beam and between the first light source and the polarization beam splitter. The first polarized light source further includes a first lens array. The first lens array is disposed on the optical path of the first light beam and between the first light source and the first polarization component. The second polarized light source includes a second light source and a second polarization component. The second light source is suitable for generating the second light beam. The second polarization component is disposed on the optical path of the second light beam and between the second light source and the polarization beam splitter. The second polarized light source further includes a second lens array. The second lens array is disposed on the optical path of the second light beam and between the second light source and the second polarization component. The first or the second polarization component for example is a PS polarization converter. The first light source or the second light source for example is a laser light source (a laser diode, for example), an LED or an arc light bulb.

To sum up, in the illumination system and the projection apparatus of the present invention, the polarization beam splitter is to compose the first and the second light beams with different polarization directions and to coincide the optical paths of the first light beam with the second light beam after the first light beam and the second light beam pass through the polarization beam splitter, so that the composite light beam is formed. Since the first and the second light beams are not reflected for a plurality of times, therefore the first and the second light beams are not likely diverged, and the divergence angle of the composite light beam is approximately equal to the divergence angle of that when single light source is employed, i.e., the light beam has a better convergence. In addition, even if the single polarized light source malfunctions, it does not cause the problem that a half of the image projected by the projection apparatus becomes dark.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural diagram of a conventional dual lamps illumination system.

FIG. 2A is a schematic structural diagram of an illumination system according to an embodiment of the present invention.

FIG. 2B and FIG. 2C respectively are schematic structural diagrams of the illumination systems of another two embodiments of the present invention.

FIG. 3A is a schematic structural diagram of a projection apparatus according to an embodiment of the present invention.

FIG. 3B is a schematic structural diagram of a projection apparatus of another embodiment of the present invention.

### DESCRIPTION OF EMBODIMENTS

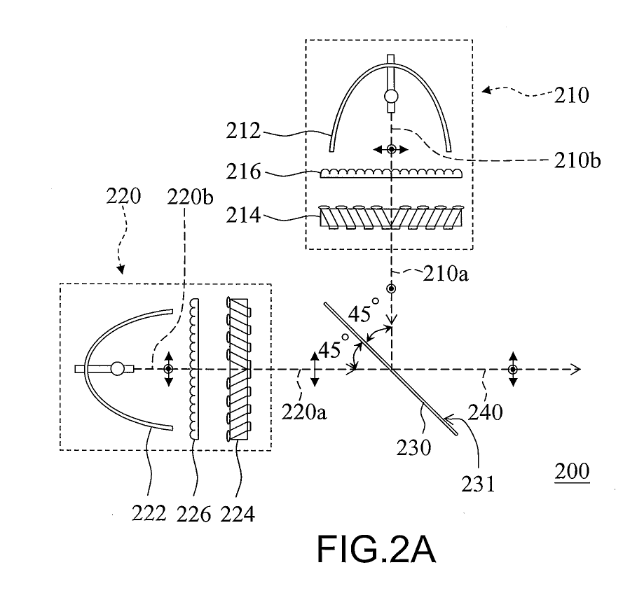

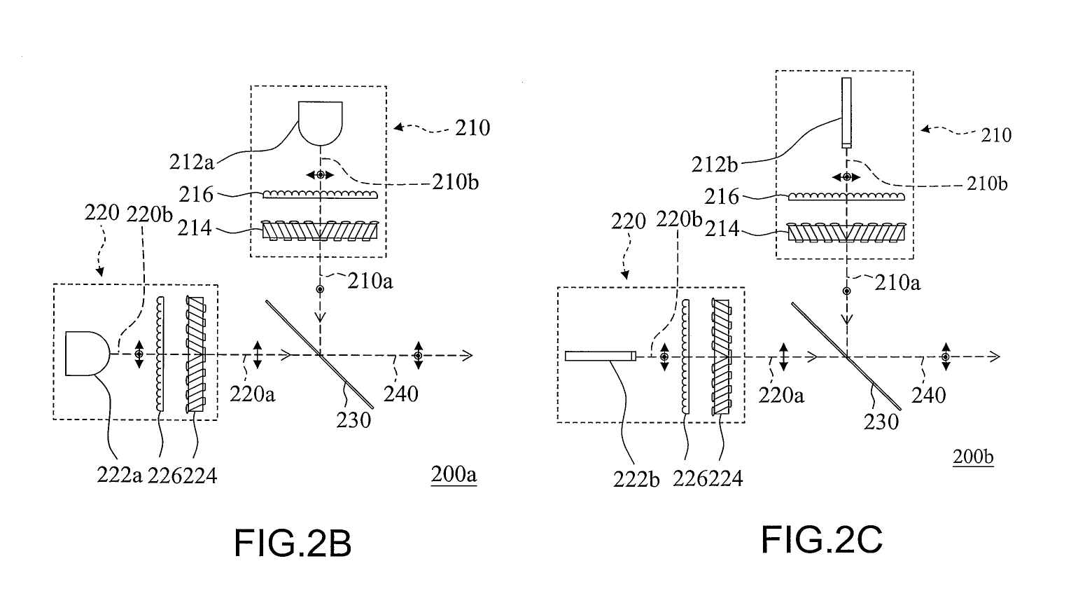

With reference to FIG. 2A, the projection apparatus 200 of the present invention includes a first polarized light source 210, a second polarized light source 220 and a polarization beam splitter 230. The first polarized light source 210 is suitable for providing a first light beam 210a with a first polarization direction, and the second polarized light source 220 is suitable for providing a second light beam 220a with a second polarization direction. The second polarization direction is orthogonal to the first polarization direction. The first light beam 210a and the second light beam 220a may be a linear-polarized light, a circular-polarized light or an elliptical-polarized light. In the present embodiment, the first light beam 210a and the second light beam 220a are linear-polarized lights, the first polarization direction is a vertical direction, while the second polarization direction is a horizontal direction, and the optical axes of the first polarized light source 210 and the second polarized light source 220 are orthogonal to each other, so that the directions of optical paths of the first light beam 210a and the second light beam 220a are orthogonal to each other.

The polarization beam splitter 230 is disposed at the intersection of the optical paths of the first light beam 210a and the second light beam 220a. The polarization beam splitter 230 is suitable for reflecting the first light beam 210a and permitting the second light beam 220a to pass through. The first light beam 210a reflected by the polarization beam splitter 230 coincides with the second light beam 210b passing through the polarization beam splitter 230 to form a composite light beam 240. In the present embodiment, the included angle between the polarization beam splitter 230 and the first light beam 210a is 45 degree, the included angle between the polarization beam splitter 230 and the second light beam 220a is 45 degree, so that the first light beam 210a is turned for 90 degree after being reflected by the polarization beam splitter 230 and then travels along the optical path direction of the second light beam 220a. The second light beam 220a penetrates through the polarization beam splitter 230 directly and then travels at the original optical path direction, thus the two light beams coincide with each other to form the composite light beam 240.

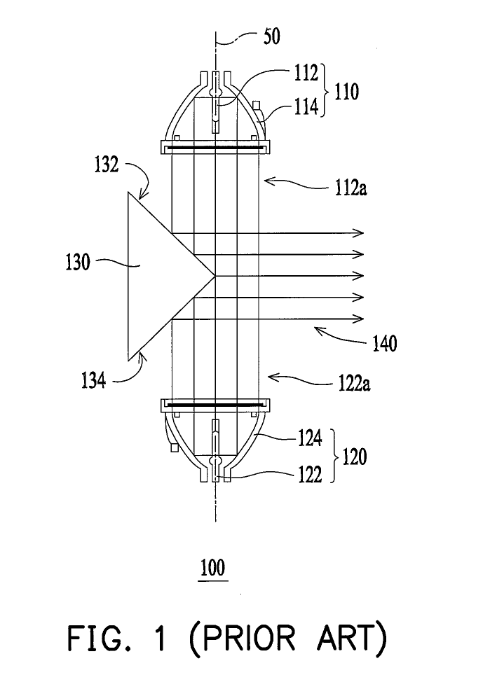

In the prior art, the parallel light beam 112a, 122a propagating in illumination system 100 shown in FIG. 1 have to be reflected for a plurality of times before the composite light beam 140 is formed. In contrary, since the second light beam 220a penetrates through the polarization beam splitter 230 directly, and the first light beam 210a is also reflected only once by the polarization beam splitter 230 and then coincides with the second light beam 220a to form the composite light beam 240, the first and the second light beam 210a and 220a are not likely diverged. Therefore, the optical angle distribution of the composite light beam 240 has a higher concentration level, i.e. the composite light beam 240 has a better convergence. After the first light beam 210a and the second light beam 220a coinciding with each other, the value of the Etendue does not increase, so that the value of the Etendue of the illumination system 200 are the same as that of the illumination system with single light source. Comparing with the illumination system with single light source, the present invention provides an illumination system with the same value of the Etendue but a higher brightness. Therefore, the light utilization is not affected while the brightness of the projection apparatus is increased.

In addition, after the first light beam 210a is emitted from the first polarized light source 210, the first light beam 210a is not reflected back to the first polarized light source 210 or propagated to the second polarized light sources 220 such that speedy aging of the first polarized light sources 210 and the second polarized light source 220 is avoided. Therefore, the first polarized light sources 210 and the second polarized light source 220 have a longer lifetime. Similarly, since the second light beam 220a is not reflected back to the second polarized light source 220 or propagated to the first polarized light source 210 as well, speedy aging of the first polarized light sources 210 and the second polarized light source 220 is also avoided. Since the first polarized light source 210 and the second polarized light source 220 both are independent light source systems which are not interfered by each other, the heat conducting systems of the first polarized light sources 210 and the second polarized light source 220 are designed independently, so that the first polarized light sources 210 and the second polarized light source 220 are both maintained at appropriate operating temperatures.

In addition, the polarization beam splitter 230 is a polarization beam splitting mirror. The polarization beam splitting mirror has a surface 231 which faces the first polarized light source 220. An invisible light filtering layer is formed on the surface 231 to filter out the infrared (IR) light and the ultra-violet (UV) light from the first light beam 210a. In an alternate embodiment, a coating is formed on the surface 231, and the proportion of the individual transmittance of the red light, the green light and the blue light in the first light beam 210a is regulated through adjusting the specification of the coating, thus the color temperature of the illumination system is altered. The present invention does not limit the types of the polarization beam splitter 230, and the polarization beam splitter 230 may also be a polarization beam splitting prism (not shown).

Still with reference to FIG. 2A, in the present embodiment, the first polarized light source 210 includes a first light source 212 and a first polarization component 214. The first light source 212 is suitable for generating a first light beam 210b which is not polarized. The first polarization component 214 is disposed on the optical path of the first light beam 210b and between the first light source 212 and the polarization beam splitter 230. The first polarization component 214 is suitable for converting the non-polarized first light beam 210b into the first light beam 210a with the first polarization direction. The second polarized light source 220 includes a second light source 222 and a second polarization component 224. The second light source 222 is suitable for generating a second light beam 220b which is not polarized. The second polarization component 224 is disposed on the optical path of the second light beam 220b and between the second light source 222 and the polarization beam splitter 230 The second polarization component 224 is suitable for converting the non-polarized second light beam 220b into the second light beam 220a with the second polarization direction.

In the present embodiment, the first polarization component 214 or the second polarization component 224 may be a PS polarization converter. However, the present invention does not limit the types of the first polarization components 214 and the second polarization components 224. For example, the first polarization components 214 and the second polarization components 224 may also be a polarizer.

Still with reference to FIG. 2A, the first polarized light source 210 further has a first lens array 216, and the second polarized light source 220 further has a second lens array 226 so as to obtain a better polarization effect when the first light beam 210b and the second light beam 220b respectively pass through the first polarization components 214 and the second polarization components 224. The first lens array 216 is disposed on the optical path of the non-polarized first light beam 210b and between the first light source 212 and the first polarization component 214. In addition, the second lens array 226 is disposed on the optical path of the non-polarized second light beam 220b and between the second light source 222 and the second polarization component 224.

Based on the above descriptions, in the present embodiment, the first light sources 212 and the second light sources 222 are arc light bulbs, and the type of the arc light bulbs are metal halide light bulbs or ultra-high pressure mercury light bulbs. However, the present invention does not limit the types of the first light sources 212 and the second light sources 222. Another embodiment of present invention will be described below in accompany with the drawings.

FIG. 2B and FIG. 2C are schematic structural diagrams of the illumination systems of another two embodiments of the present invention, respectively. With reference to FIG. 2B and FIG. 2C, the illumination systems of 220a, 220b is similar to the illumination system 220 as shown in FIG. 2A, the main difference is that the illumination system 200a uses LEDs as the first light sources 212a and the second light sources 222a, and the illumination system 200b uses laser light sources (laser diodes, for example) as the first light sources 212b and the second light sources 222b.

In the embodiments previously described, the configurations of the illumination system 200, 200a, 200b are all very compact and occupy not much space, thus it is helpful to reduce the whole volume of the projection apparatus.

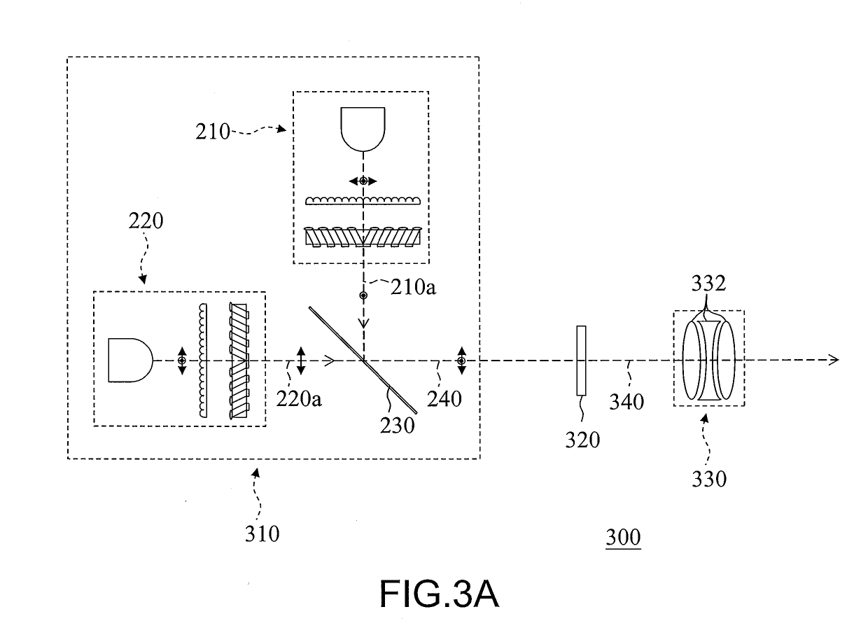

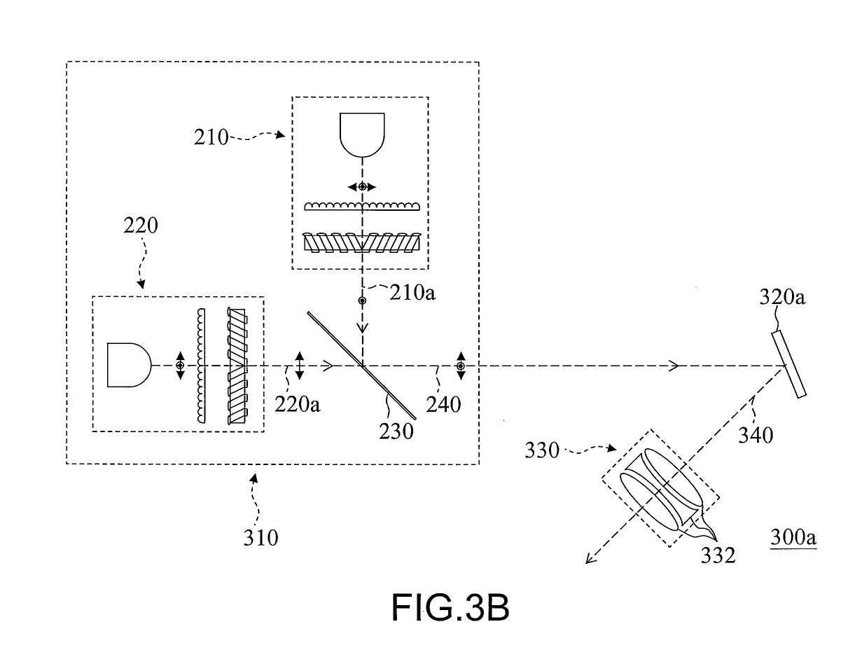

With reference to FIG. 3A, the projection apparatus 300 of the present invention includes an illumination system 310, a light valve 320 and an imaging system 330. The illumination system 310 may be the illumination systems of the embodiments described previously (as shown in FIGS. 2A˜2C) or other illumination systems with the characteristics of the present invention. The illumination system 310 is suitable for providing the composite light beam 240. The composite light beam 240 is formed by coinciding the first light beam 210a reflected by the polarization beam splitter 230 with the second light beam 220a passing through the polarization beam splitter 230. The first light beam 210a is provided by the first polarized light source 210, and the second light beam 220a is provided by the second polarized light source 220.

The light valve 320 is disposed on the optical path of the composite light beam 240, and is suitable for converting the composite light beam 240 into an image light beam 340. The imaging system 330 is disposed on the optical path of the image light beam 340, and is suitable for projecting the image light beam 340 on the screen (not shown) to generate the image. Since the composite light beam 240 is formed by coinciding the first light beam 210a with the second light beam 220a, and the first light beams 210a and the second light beams 220a are respectively provided by the first polarized light sources 210 and the second polarized light sources 220 which are independent to each other, therefore even if one of the polarized light source (210, 220) is damaged, the half-dark phenomenon on the image does not occur.

In the present embodiment, the imaging system 330 may have a plurality of lenses 332. In addition, the light valve 320 may be a transmissive light valve such as a transmissive LCD panel. However, the present invention does not limit the type of the light valve 320. Another embodiment will be described below in accompany with the drawings.

FIG. 3B is a schematic structural diagram of a projection apparatus of another embodiment of the present invention. With reference to FIG. 3B, the projection apparatus 300a of the present embodiment is similar to the projection apparatus 300 shown in FIG. 3A, the main difference is that the light valve 320a of the projection apparatus 300a is a reflective light valve. Specifically, the light valve 320a may be a Digital Micro-mirror. Device (DMD) or a Liquid Crystal on Silicon micro-display (LCOS micro-display).

To sum up, the illumination system and the projection apparatus of the present invention at least have the following advantages:

1. Since the second light beam passes through the polarization beam splitter directly and the first light beam is also reflected only once by the polarization beam splitter and then coincides with the second light beam to form the composite light beam, the first and the second light beam do not easily diverge. As a result, the composite light beam has a better convergence, and the composite light beam has the same value of Etendue as that of the illumination system with the single light source.

2. Since the composite light beam is formed by coinciding the first light beam with the second light beam, and the first light beam and the second light beam are respectively provided by the first polarized light source and the second polarized light source which are independent to each other, the half-dark situation on the image does not occur even if single polarized light source is damaged.

3. Since the first light beam and the second light beam both are not reflected to the first polarized light source or the second polarized light source, the speedy aging of the first and the second polarized light sources is avoided. Therefore, the first and the second polarized light sources have a longer lifetime.

4. The heat conducting systems of the first and the second polarized light sources can be respectively and independently designed, so that the first polarized light source and the second polarized light source both can be at an appropriate operating temperature.

5. The configuration of the illumination system is compact and occupies not much space, which is very helpful to reduce the whole volume of the projection apparatus, so as to meet the requirement of the trend of miniaturization.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising:
a first polarized light source, suitable for providing a first light beam with a first polarization direction;
a second polarized light source, suitable for providing a second light beam with a second polarization direction orthogonal to the first polarization direction; and
a polarization beam splitter, disposed on the intersection of optical paths of the first light beam and the second light beam, wherein the polarization beam splitter is suitable for reflecting the first light beam and permitting the second light beam to pass through, and the first light beam reflected by the polarization beam splitter coincides with the second light beam passing through the polarization beam splitter.

2. The illumination system as claimed in claim 1, wherein an optical axis of the first polarized light source is orthogonal to an optical axis of the second polarized light source, and an included angle between the polarization beam splitter and each optical axis is 45 degree.

3. The illumination system as claimed in claim 1, wherein the first polarized light source comprises:
a first light source, suitable for generating the first light beam; and
a first polarization component, disposed on an optical path of the first light beam and between the first light source and the polarization beam splitter.

4. The illumination system as claimed in claim 3, wherein the first polarized light source further comprises a first lens array disposed on the optical path of the first light beam and between the first light source and first polarization component.

5. The illumination system as claimed in claim 3, wherein the first polarization component comprises a polarization converter.

6. The illumination system as claimed in claim 3, wherein the first light source comprises a laser light source, an LED or an arc light bulb.

7. The illumination system as claimed in claim 1, wherein the second polarized light source comprises:
a second light source, suitable for generating the second light beam; and
a second polarization component, disposed on an optical path of the second light beam and between the second light source and the polarization beam splitter.

8. The illumination system as claimed in claim 7, wherein the second polarized light source further comprises a second lens array disposed on the optical path of the second light beam and between the second light source and second polarization component.

9. The illumination system as claimed in claim 7, wherein the second polarization component comprises a polarization converter.

10. The illumination system as claimed in claim 7, wherein the second light source comprises a laser light source, an LED or an arc light bulb.

11. The illumination system as claimed in claim 1, wherein the polarization beam splitter comprises a polarization beam splitting mirror or a polarization beam splitting prism.

12. A projection apparatus, comprising:
an illumination system, comprising:
a first polarized light source, suitable for providing a first light beam with a first polarization direction;
a second polarized light source, suitable for providing a second light beam with a second polarization direction orthogonal to the first polarization direction; and
a polarization beam splitter, disposed on the intersection of optical paths of the first light beam and the second light beam, wherein the polarization beam splitter is suitable for reflecting the first light beam and permitting the second light beam to pass through, and the first light beam reflected by the polarization beam splitter coincides with the second light beam passing through the polarization beam splitter to form a composite light beam;
a light valve, disposed on an optical path of the composite light beam for converting the composite light beam into an image light beam; and
an imaging system, disposed on an optical path of the image light beam.

13. The projection apparatus as claimed in claim 12, wherein an optical axis of the first polarized light source is orthogonal to an optical axis of the second polarized light source, and an included angle between the polarization beam splitter and each optical axis is 45 degree.

14. The projection apparatus as claimed in claim 12, wherein the first polarized light source comprises a first light source suitable for generating the first light beam and a first polarization component disposed on an optical path of the first light beam and between the first light source and the first polarization beam splitter, and the second polarized light source comprises a second light source suitable for generating the second light beam and a second polarization component disposed on an optical path of the second light beam and between the second light source and the second polarization beam splitter.

15. The projection apparatus as claimed in claim 14, wherein the first polarized light source further comprises a first lens array disposed on the optical path of the first light beam and between the first light source and first polarization component, and the second polarized light source further comprises a second lens array disposed on the optical path of the second light beam and between the second light source and second polarization component.

16. The projection apparatus as claimed in claim 14, wherein the first polarization component and the second polarization component comprise a polarization converter respectively.

17. The projection apparatus as claimed in claim 14, wherein the first light source and the second light source comprise a laser light source, an LED or an arc light bulb respectively.

18. The projection apparatus as claimed in claim 12, wherein the polarization beam splitter comprises a polarization beam splitting mirror or a polarization beam splitting prism.

19. The projection apparatus as claimed in claim 12, wherein the polarization beam splitter comprises a polarization beam splitting mirror with an invisible light filter disposed on a surface that faces the first polarized light source.

20. The projection apparatus as claimed in claim 12, wherein the polarization beam splitter comprises a polarization beam splitting mirror with a coating disposed on a surface that faces the first polarized light source, thus the color temperature of the first light beam is regulated.
